(19) United States
(12) Patent Application Publication
(10) Pub. No.: US 2025/0347930 A1
(43) Pub. Date: Nov. 13, 2025

(54) HINGE ASSEMBLY FOR SMART GLASSES AND SMART GLASSES COMPRISING SUCH A HINGE ASSEMBLY

(71) Applicant: LUXOTTICA S.R.L., Agordo (BL) (IT)

(72) Inventor: Moreno DAL PONT, Belluno (BL) (IT)

(21) Appl. No.: 18/869,225

(22) PCT Filed: May 25, 2023
(86) PCT No.: PCT/IB2023/055361

§ 371 Date: Nov. 25, 2024

(30) Foreign Application Priority Data
May 25, 2022 (IT) 102022000010943

(51) Int. Cl. G02C 5/22; G02C 11/00

(52) U.S. Cl. CPC G02C 5/2227; G02C 11/10; G02C 2200/26

(57) ABSTRACT

Hinge assembly for smart glasses (100) comprising: a support plate (110) which comprises a first cantilevered portion (113) and a second cantilevered portion (114), the support plate (110) comprising an opening (190) between said first cantilevered portion (113) and said second cantilevered portion (114), the support plate (110) comprising a first side wall (128) and a second side wall (129) connecting said first cantilevered portion (113) to said second cantilevered portion (114): a support body (130) rotatably coupled to the support plate (110); a masking and guide body (180) for an electrical cable (220) interposed between the cantilevered portions (113, 114), the masking and guide body (180) for the electrical cable (220) comprising a first rest portion (183) and a second rest portion (184) spaced from each other and at least one bridge element (185) connecting the rest portions (183, 184) to each other, the rest portions (183, 184) facing each other and defining a free gap between them, the distance between said side walls (128, 129) is such as to determine a first angular delay between the rotation of the support body (130) and the rotation of the masking and guide body (180) for the electrical cable (220) and a second angular delay between the rotation of the support body (130) and the rotation of the masking and guide body (180) for the electrical cable (220).

The present invention relates to a hinge assembly for smart glasses employable in smart glasses.

The present invention also relates to smart glasses comprising such a hinge assembly.

As known, smart glasses, also referred to as intelligent glasses or virtual glasses or digital glasses, mean a pair of glasses comprising electronic devices adapted to operate as a computer able to provide support to the activities performed by the user wearing them, both in the daily and private sphere and in the working and business sphere, or in any other particular sphere.

Currently used smart glasses allow to display required information and/or objects on the lenses or to use voice commands to interact with the glasses themselves, so as to save time and financial cost on many operations, and further allow the user to work more safely, having both hands free.

In more detail, smart glasses currently available on the market are composed by electronic devices and software able to play video or audio, film, operate computer applications, recognize the natural language, the shapes and the objects arranged in the surrounding environment.

Smart glasses are provided with a displaying device, such as for example a display, typically integrated in the lenses of the frame for glasses or arranged thereon, and an electronic processing and control unit, such as for example a controller or a battery, usually integrated in the frame for glasses or in the temples thereof.

Thereby, it is necessary to electrically connect the front of the frame for glasses, where the lenses are arranged, to the electronic components located on the temple of the frame itself. Smart glasses are generally provided with a common hinge and a cable passing therein. In common hinges, however, during the rotation of the temples with respect to the frame for glasses to pass from an opening operating position to a closing one, the cable can excessively bend and deteriorate or even break under stress exerted by the hinge itself or change its shape and/or size in addition to the limits of its elasticity.

Furthermore, as known, smart glasses provided with a bistable hinge are available on the market.

The bistability of the hinge allows to keep the temple of the frame for glasses stationary and stable in the operating position in which it is, that is opening or closing, preventing it from moving accidentally and without the user's will, causing discomfort to the latter.

For example, document DE102020210683B3 discloses a bistable hinge of a frame for glasses made of a first joint region configured to connect the hinge to the front of the frame for glasses and identify a first joint axis, and of a second joint region configured to connect the hinge to the temple of the frame for glasses and identify a second joint axis, and having a recess, perpendicular to the first and second joint axes, acting as a guide to accommodate a cable connecting the front to the temple of the frame for glasses.

However, such hinges do not allow to reach a further flexible extra-opening operating position, referred to as “extra-flex” operating position, wherein the angle formed between the temple and the front of the frame for glasses is greater than 90 degrees when the temples are open.

The “extra-flex” operating position allows an easier wearing operation by the user just because of the flexible extra-opening of the temples, and a greater comfort when the user wears such glasses.

Hinges which provide the reaching of the “extra-flex” operating position will be referred to as flexible below.

However, a bistable and flexible hinge should also allow to accommodate a flexible cable therein for data communication and/or electrical power between front and temple, preventing it from damaging or breaking under stress of the hinge itself when the frame for glasses passes from an opening operating configuration to a closing one or an “extra-flex” one, or vice versa.

An object of the present invention is to overcome the above-mentioned drawbacks and in particular to devise a hinge assembly for smart glasses which allows to accommodate a flexible cable therein, preventing the excessive stress exerted by the hinge on the cable itself from damaging or breaking it.

Another object of the present invention is to provide a hinge assembly for smart glasses, which is bistable, and which is simultaneously “extra-flex.”

Still an object of the present invention is to make smart glasses ensuring that the risk of damaging or breaking the flexible cable is avoided.

These and other objects according to the present invention are achieved by making a hinge assembly for smart glasses as set forth in claim 1 and smart glasses as defined in claim 11.

Further features of the hinge assembly for smart glasses and the smart glasses are object of the dependent claims.

The features and advantages of a hinge assembly for smart glasses and the smart glasses according to the present invention will be more apparent from the following exemplary and non-limiting description referred to the attached schematic drawings, in which:

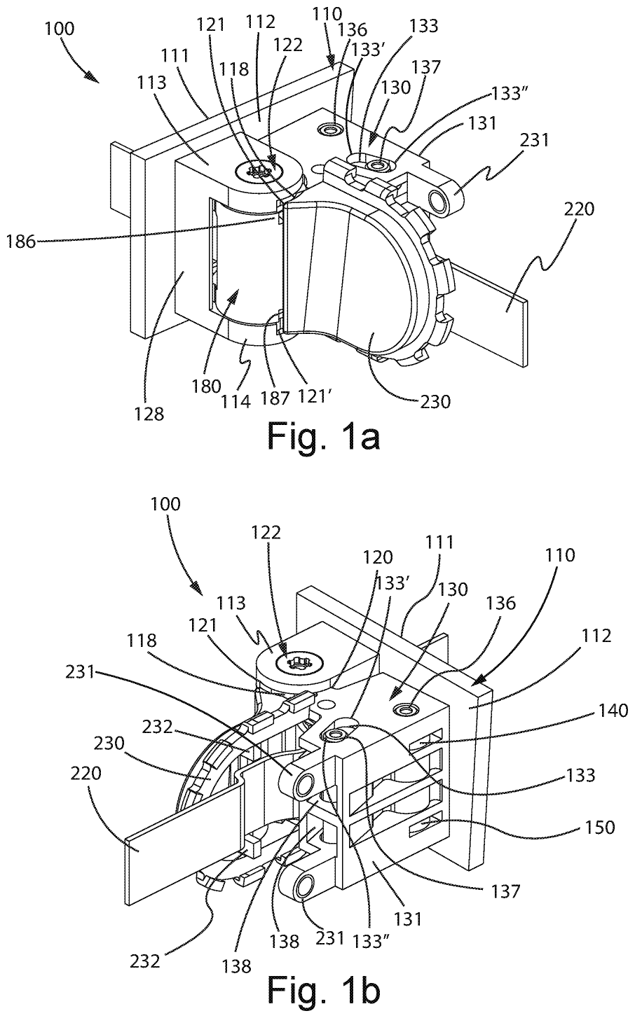

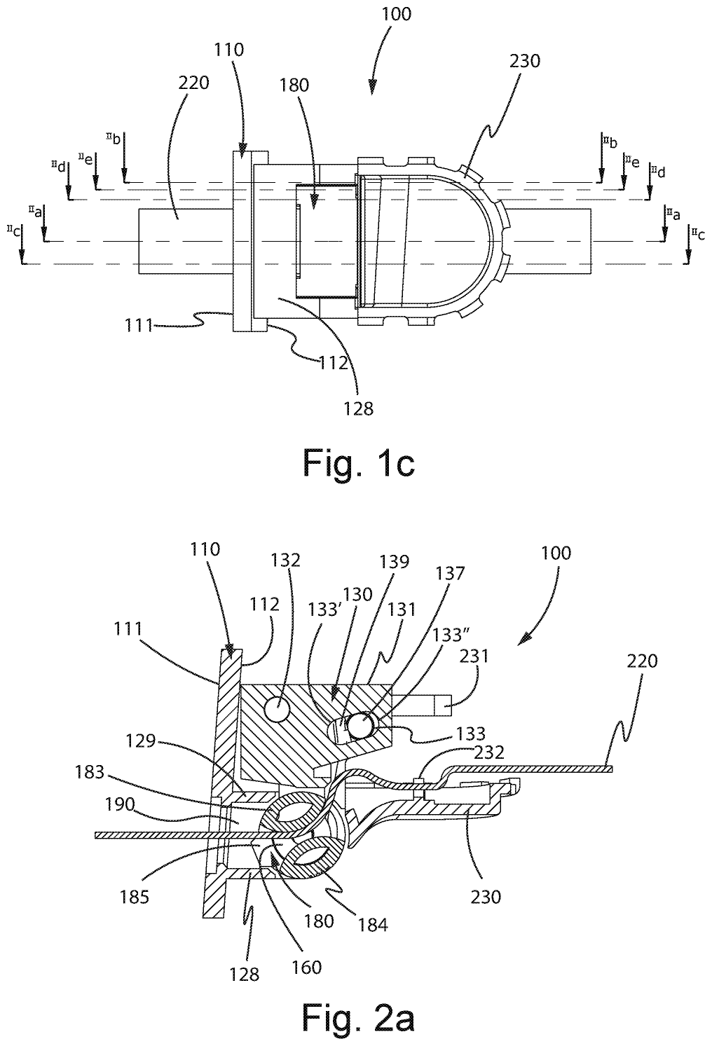

FIG. 1a is a first perspective view of a hinge assembly for smart glasses according to the present invention when it is in a first stable opening position;

FIG. 1b is a second perspective view of the hinge assembly for smart glasses of FIG. 1a;

FIG. 1c is a first front view, taken from the space interposed between the temple and the front of the glasses, of the hinge assembly for smart glasses of FIG. 1a;

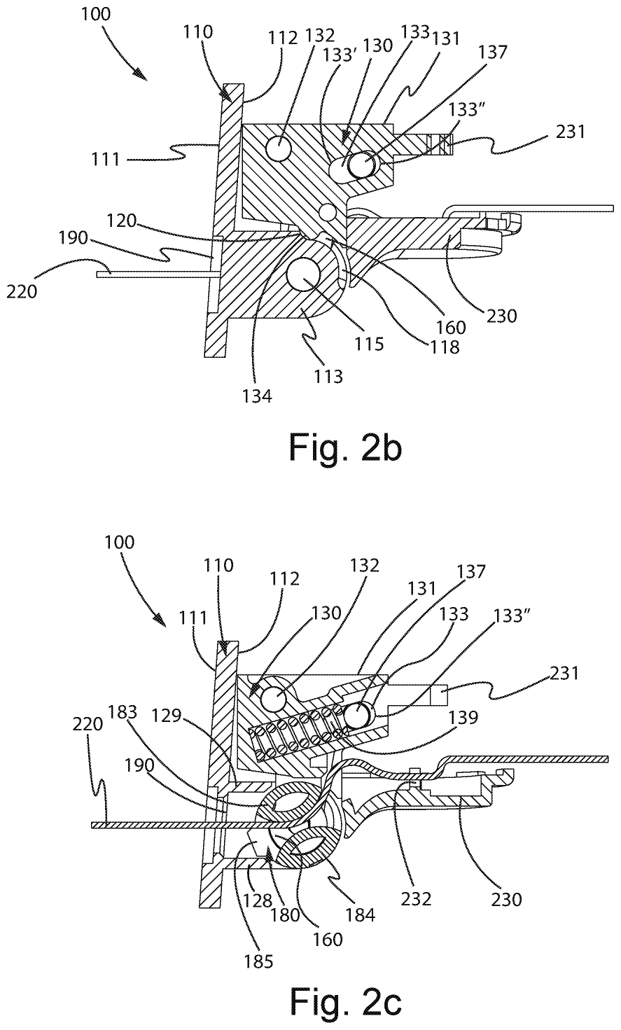

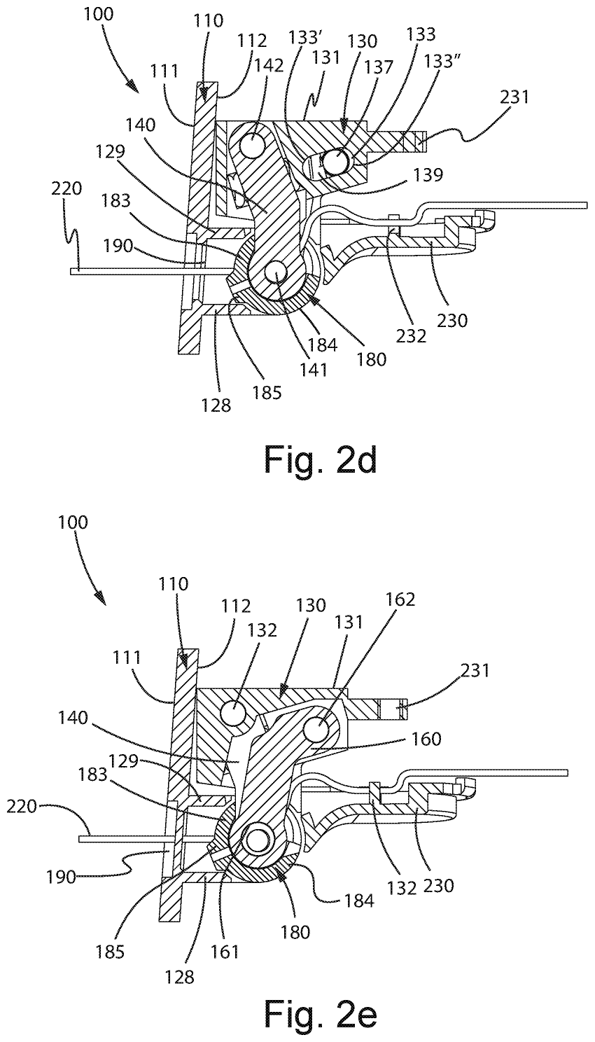

FIGS. 2a, 2b, 2c, 2d, 2e are five sectional views respectively along the lines IIa-IIa, IIb-IIb, IIc-IIc, IId-IId, IIe-IIe of the hinge assembly for smart glasses of FIG. 1c;

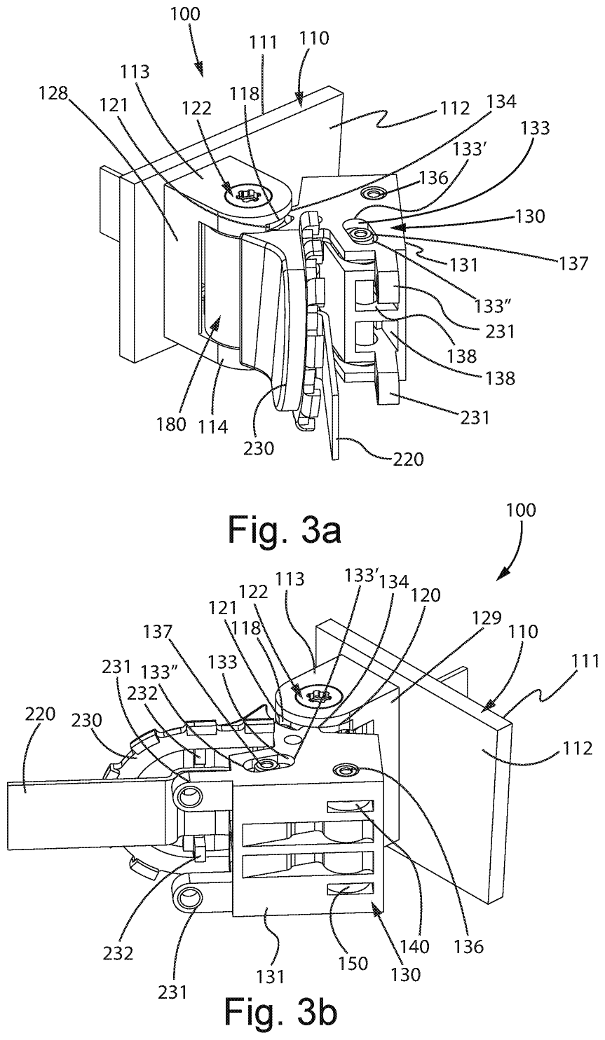

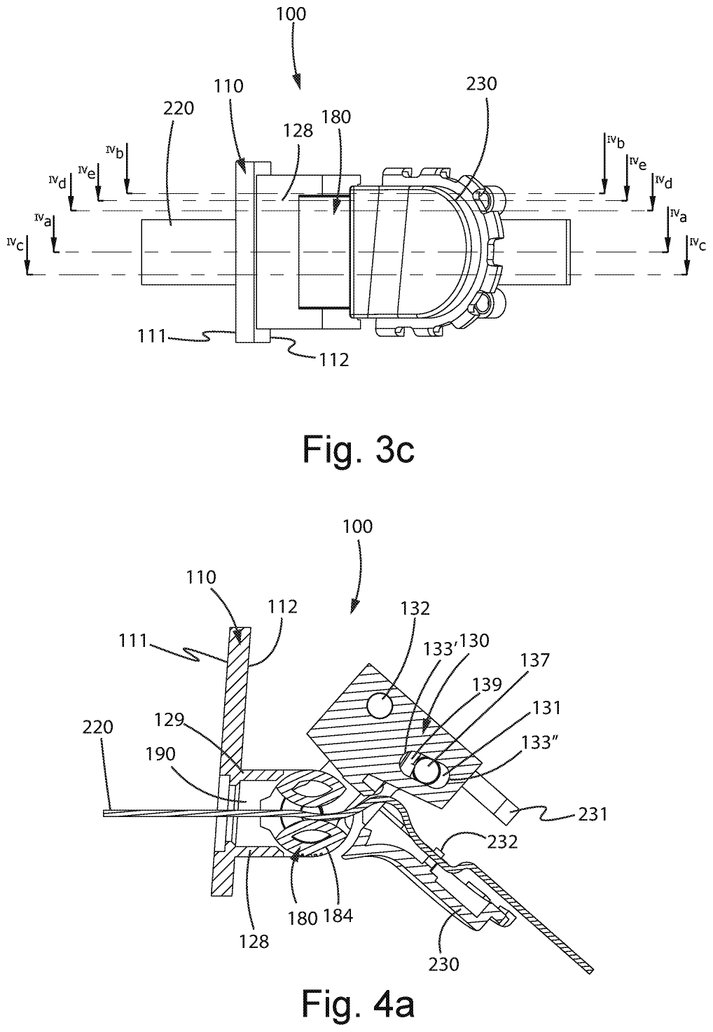

FIG. 3a is a third perspective view of the hinge assembly for smart glasses according to the present invention when it is in an intermediate position between the first stable opening position and a second stable closing position;

FIG. 3b is a fourth perspective view of the hinge assembly for smart glasses of FIG. 3a;

FIG. 3c is a second front view, taken from the space interposed between the temple and the front, of the hinge assembly for smart glasses of FIG. 3a;

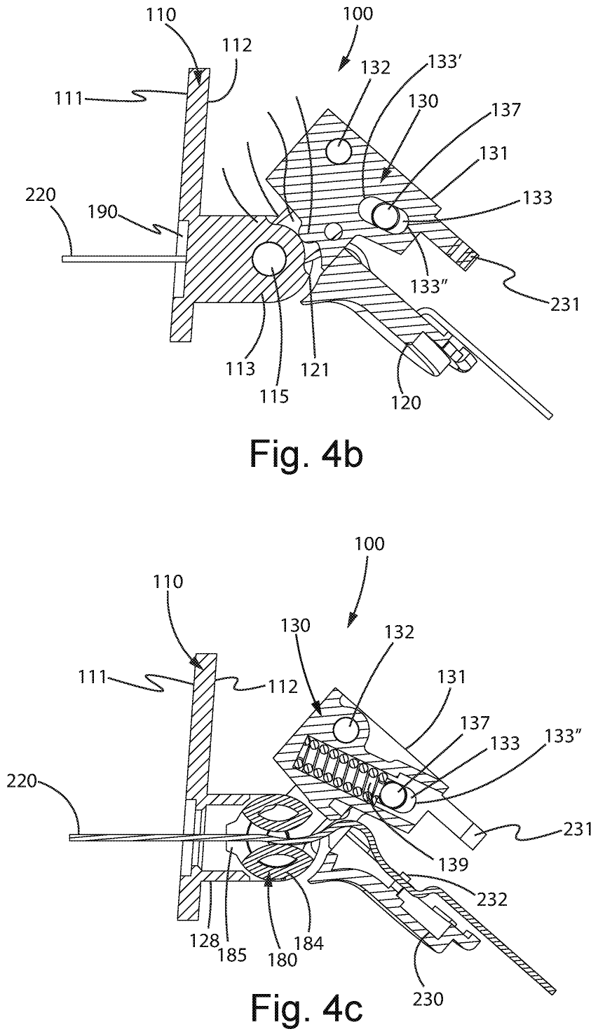

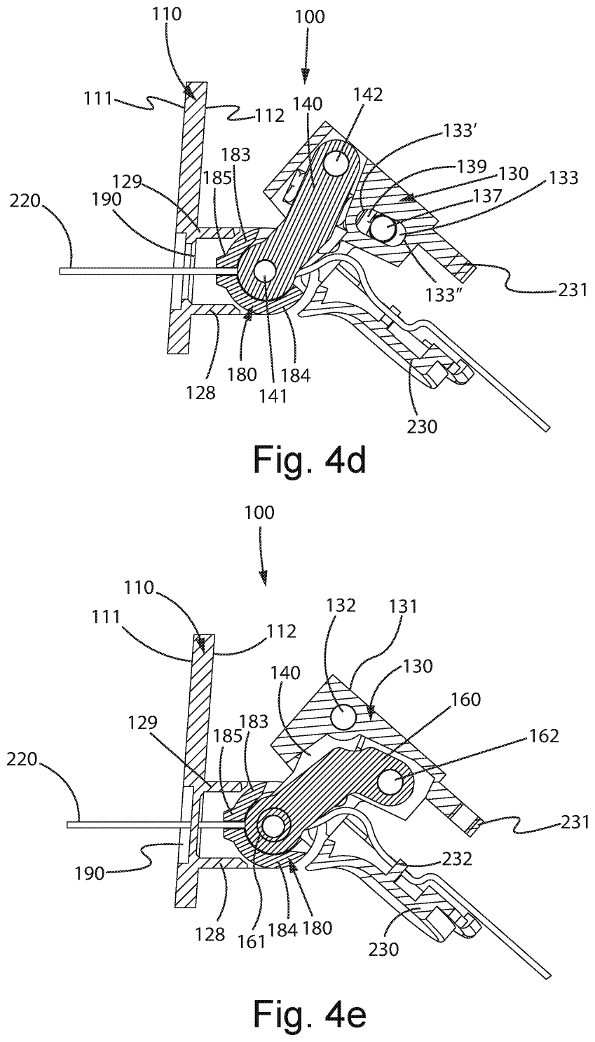

FIGS. 4a, 4b, 4c, 4d, 4e are five sectional views respectively along the lines IVa-IVa, IVb-IVb, IVc-IVc, IVd-IVd, IVe-IVe of the hinge assembly for glasses of FIG. 3c;

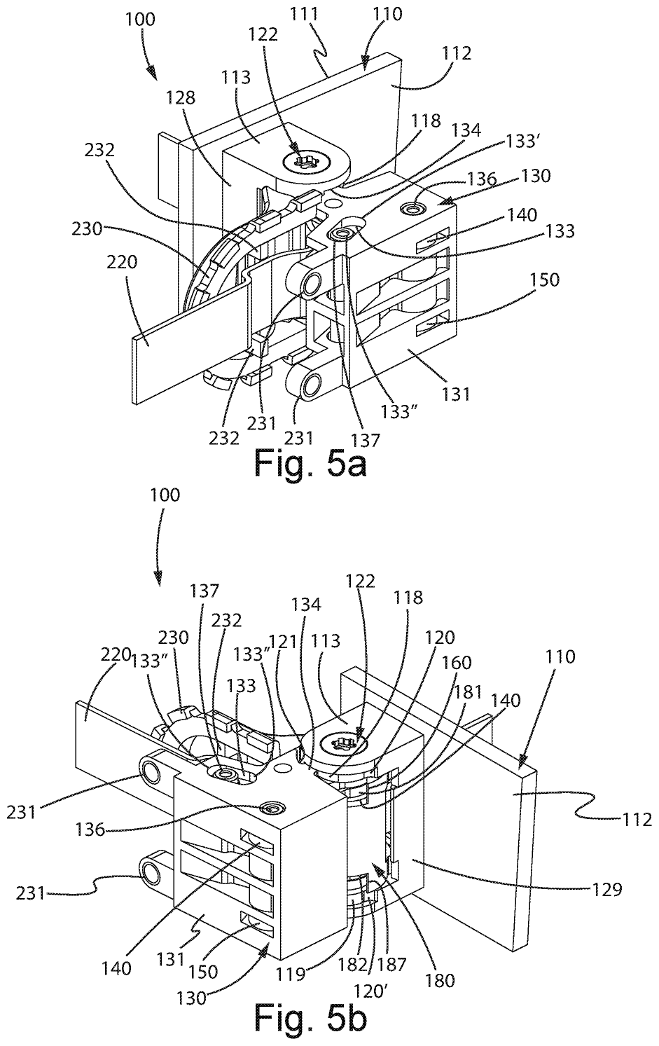

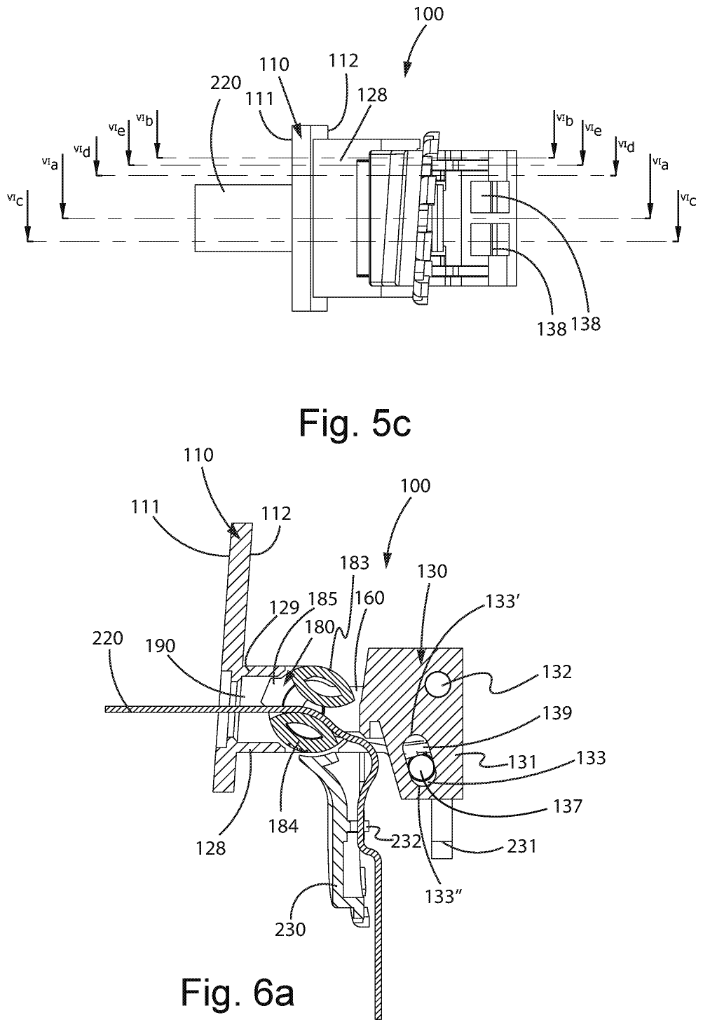

FIG. 5a is a fifth perspective view of the hinge assembly for smart glasses according to the present invention when it is in the second stable closing position;

FIG. 5b is a sixth perspective view of the hinge assembly for smart glasses of FIG. 5a;

FIG. 5c is a third front view, taken from the space interposed between the temple and the front, of the hinge assembly for smart glasses of FIG. 5a;

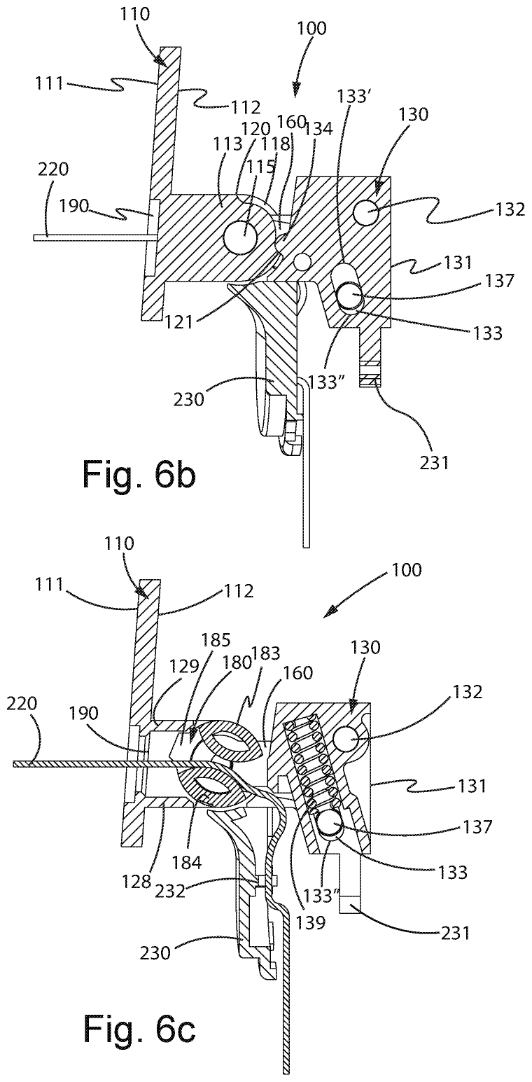

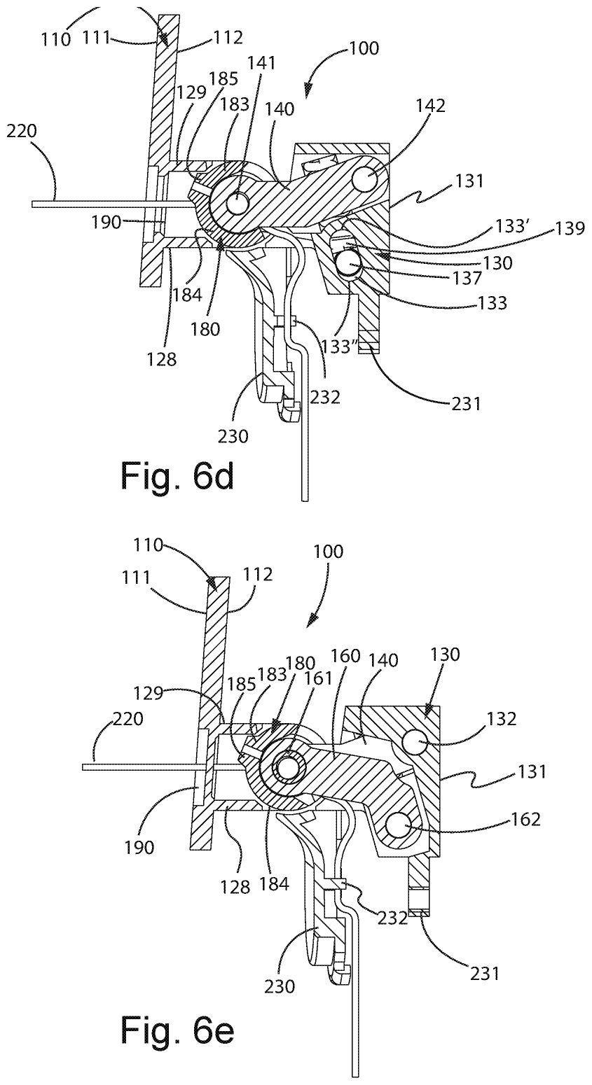

FIGS. 6a, 6b, 6c, 6d, 6e are five sectional views respectively along the lines VIa-VIa, VIb-VIb, VIc-VIc, VId-VId, VIe-VIe of the hinge assembly for smart glasses of FIG. 5c;

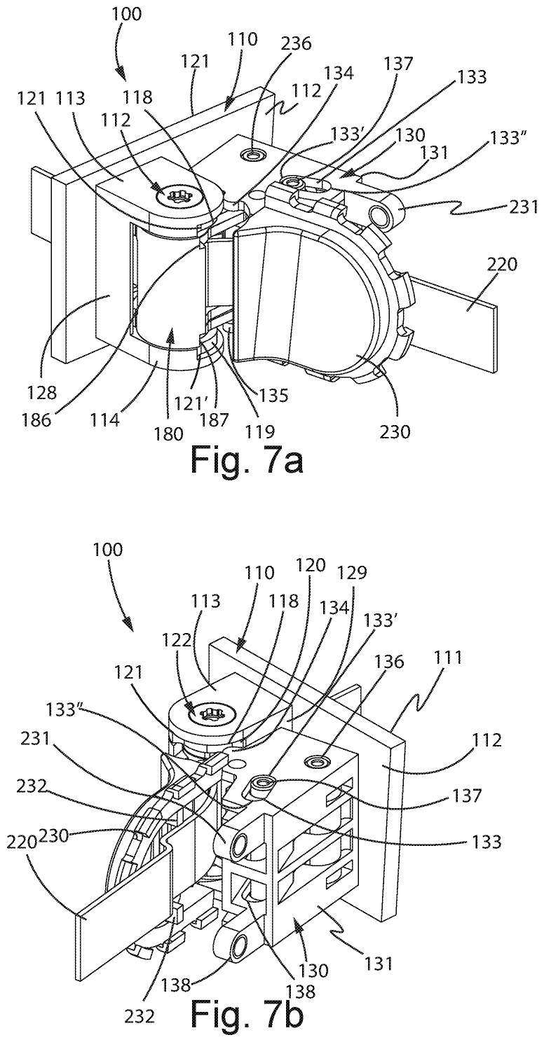

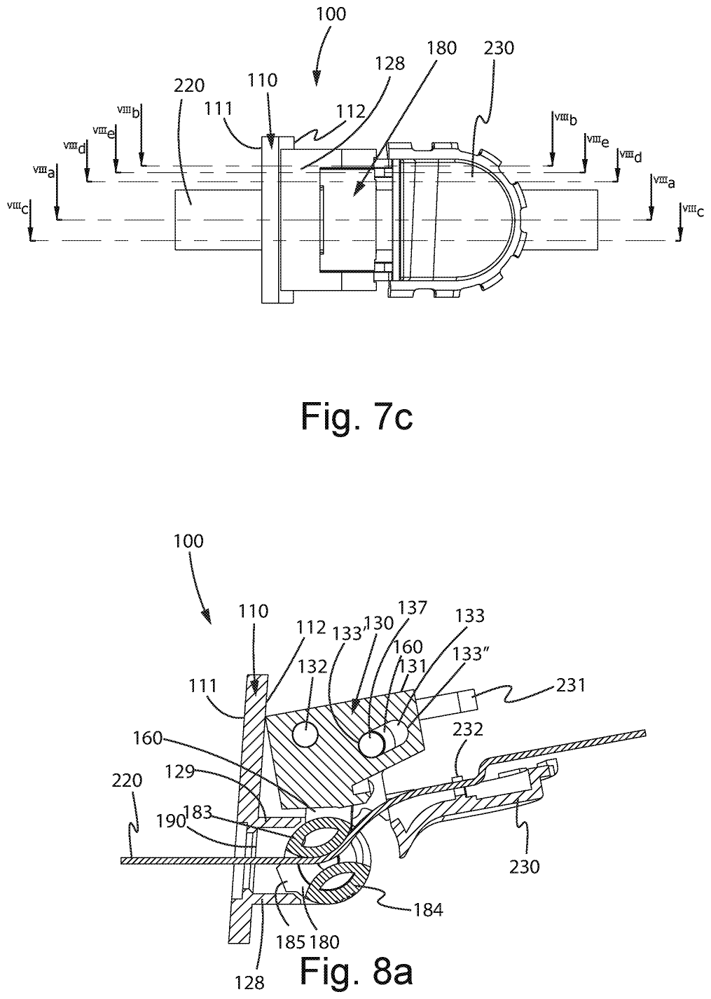

FIG. 7a is a seventh perspective view of the hinge assembly for smart glasses according to the present invention when it is in a third unstable extra-opening position;

FIG. 7b is an eighth perspective view of the hinge assembly for smart glasses of FIG. 7a;

FIG. 7c is a fourth front view, taken from the space interposed between the temple and the front, of the hinge assembly for smart glasses of FIG. 7a;

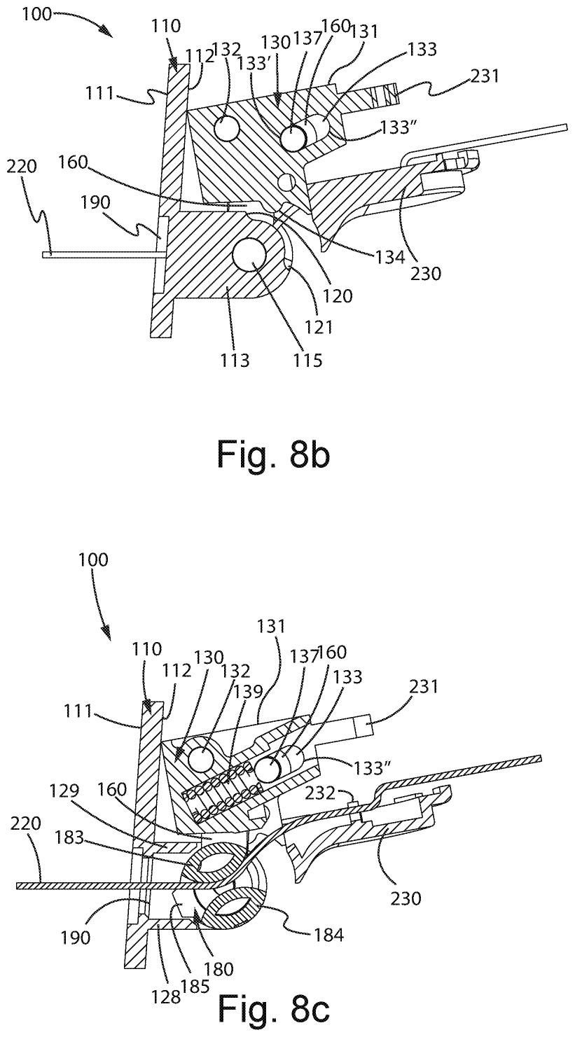

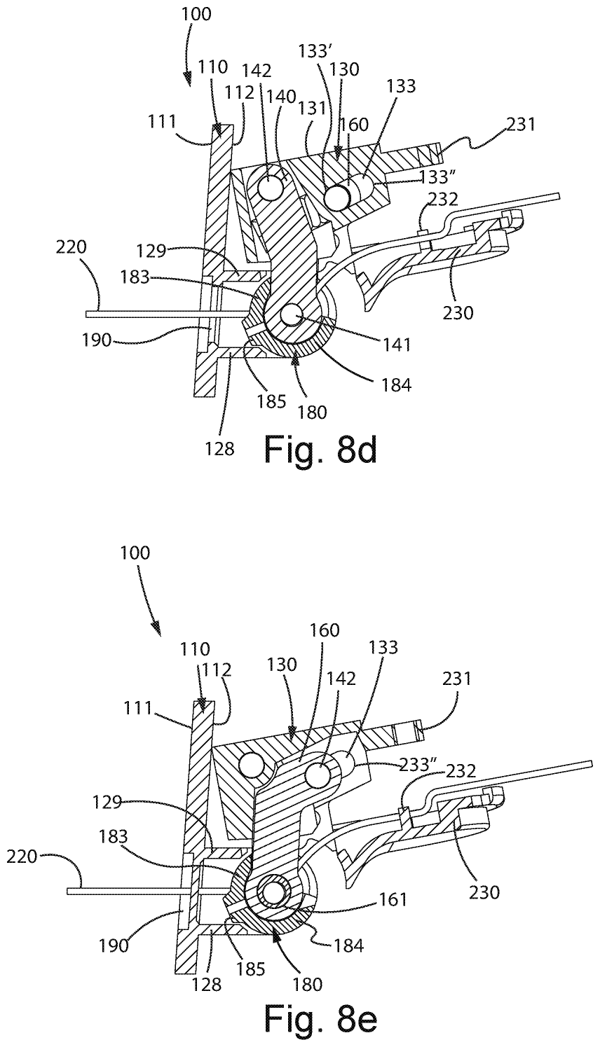

FIGS. 8a, 8b, 8c, 8d, 8e are five sectional views respectively along the lines VIIIa-VIIIa, VIIIb-VIIIb, VIIIc-VIIIc, VIIId-VIIId, VIIIe-VIIIe of the hinge assembly for smart glasses of FIG. 7c;

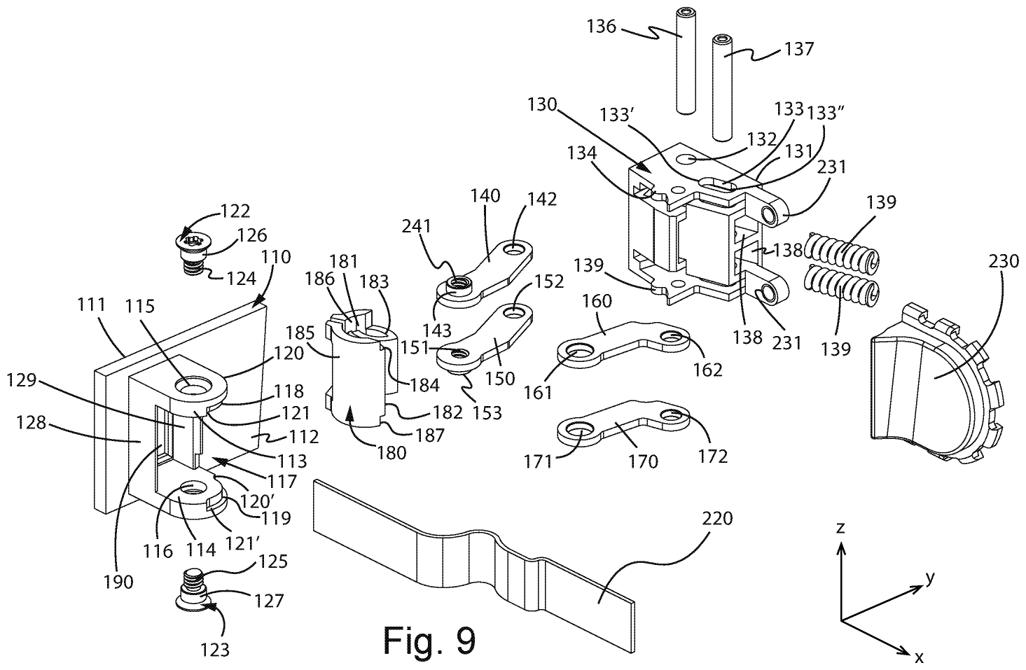

FIG. 9 is a ninth exploded perspective view of the hinge assembly for smart glasses according to the present invention;

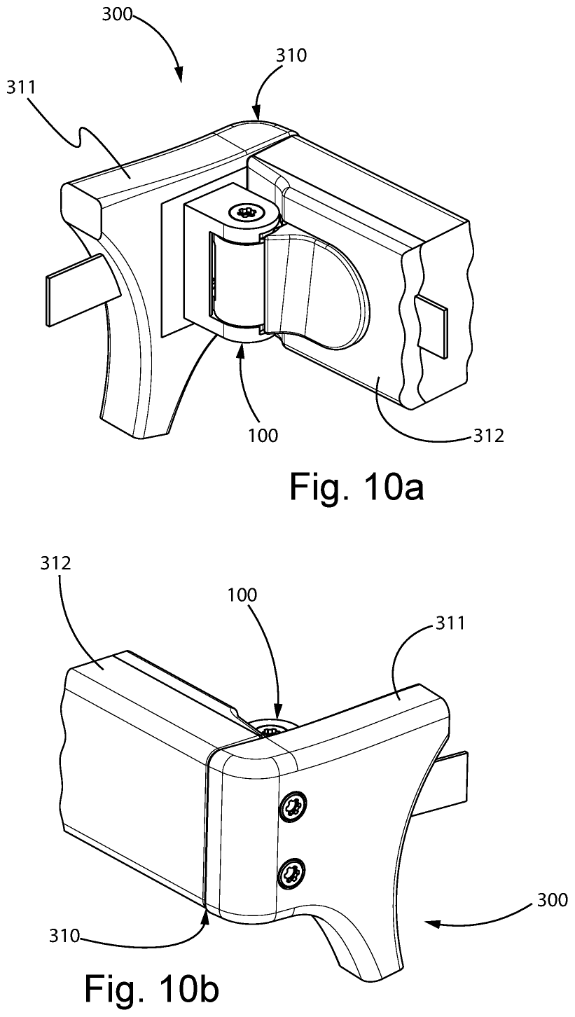

FIGS. 10a and 10b are two partial perspective schematic views of smart glasses according to the present invention.

With reference to the attached figures, a hinge assembly for smart glasses overall denoted by 100 is shown.

The hinge assembly for smart glasses 100 can be advantageously mounted in a pair of smart glasses 300 as, for example, illustrated in FIG. 10a and in FIG. 10b. Such smart glasses 300 comprise a frame 310 comprising in turn a front 311 adapted to carry two lenses and two temples 312 adapted to allow a user to wear the smart glasses 300, two hinge assemblies for smart glasses 100 each of which couples a respective temple 312 to the front 311.

Furthermore, the smart glasses 300 also comprise an electrical cable 220, preferably flexible, adapted to electrically connect electrical and/or electronic devices to each other that are installed in the front 311 and in the temples 312.

In the present disclosure, reference will be made for simplicity and clarity of exposition to a Cartesian axis system xyz depicted in figures comprising a transverse axis x, a longitudinal axis y and a vertical axis z and to an orientation of the hinge assembly for smart glasses 100 like that illustrated in FIG. 9.

The hinge assembly for smart glasses 100 comprises a support plate 110 provided with a first face 111 substantially flat and second a face 112 substantially flat opposite and parallel to the first. Particularly, the first face 111 is intended to be applied to a front 311 of the frame 310. Furthermore, the support plate 110 comprises a first cantilevered portion 113 and a second cantilevered portion 114 parallel and opposite to each other extending from the second face 112 in a direction substantially perpendicular to it, i.e., in a direction substantially parallel to the transverse axis x.

The two cantilevered portions 113, 114 identify a free space between them which makes a receiving seat 117.

Furthermore, the support plate 110 also comprises two side walls 128, 129 connecting the first cantilevered portion 113 to the second cantilevered portion 114. Furthermore, the support plate 110 also comprises an opening 190 positioned along the vertical direction z between the first cantilevered portion 113 and the second cantilevered portion 114 and along the longitudinal direction y between the two side walls 128, 129.

The hinge assembly for smart glasses 100 also comprises a support body 130 intended to be applied to the temple 312. In particular, the support body 130 has a box shape and a first face 131 substantially flat intended to be fixed to the temple 312.

Advantageously, the support body 130 is rotatably coupled to the support plate 110 so as to be able to rotate between a first stable opening position of the hinge assembly for smart glasses 100, corresponding to the position in which the temples 312 of the glasses 300 are open and the glasses 300 can be worn, and a second stable closing position of the hinge assembly for smart glasses 100, corresponding to the position in which the temples 312 of the glasses 300 are closed and the glasses 300 cannot be worn.

The hinge assembly for smart glasses 100 also comprises a masking and guide body 180 for the electrical cable 220 extending along the axis z between a first end 181 and a second end 182. Such masking and guide body 180 for the electrical cable 220 is interposed between the two cantilevered portions 113, 114 in the receiving seat 117 such that the first end 181 faces the first cantilevered portion 113 and the second end 182 faces the second cantilevered portion 114.

Furthermore, the masking and guide body 180 for the electrical cable 220 comprises a first rest portion 183 and a second rest portion 184 spaced from each other extending in length between the first end 181 and the second end 182, and at least one bridge element 185 connecting such rest portions 183, 184 to each other. Therefore, the two rest portions 183, 184 face each other and define a free gap between them. The hinge assembly for smart glasses 100 further comprises a covering element 230 that can be coupled to the support body 130 or made in a single piece with such support body 130. In any case, the covering element 230 is integral with the support body 130.

Advantageously, the support body 130 comprises at least one anchoring protrusion 231 adapted to be fixed on the temple 312 of the glasses 300. In detail, the temple 312 is interposed between the at least one anchoring protrusion 231 of the support body 130 and the covering element 230.

In detail, the electrical cable 220 coming from the front 311 of the glasses 300 crosses the opening 190 of the support plate 110 and the gap between the rest portions 183, 184 engaging to engaging portions 232 of the covering element 230.

When the hinge assembly for smart glasses 100 is in the first stable opening position, the at least one bridge element 185 of the masking and guide body 180 for the electrical cable 220 is in contact and in abutment with the first side wall 128 of the support plate 110; furthermore, the electrical cable 220 is in contact and in abutment with a surface of the first rest portion 183 of the masking and guide body 180 for the electrical cable 220.

When the hinge assembly for smart glasses 100 is in the second stable closing position, the at least one bridge element 185 of the masking and guide body 180 for the electrical cable 220 is in contact and in abutment with the second side wall 129 of the support plate 110; furthermore, the electrical cable 220 is in contact and in abutment with a surface of the second rest portion 184 of the masking and guide body 180 for the electrical cable 220.

When the hinge assembly for smart glasses 100 passes from the first stable opening position to the second stable closing position, the electrical cable 220 is drawn in rotation by the covering element 230 that leads it to detach from the first rest portion 183 until contacting the second rest portion 184. At this point, the electrical cable 220 draws in rotation the masking and guide body 180 for the electrical cable 220, the at least one bridge element 185 is detached from the first side wall 128 and rotates together with the masking and guide body 180 for the electrical cable 220 towards the second side wall 129 of the support plate 110. During an initial phase of the rotation of the support body 130 the masking and guide body 180 for the electrical cable 220 does not rotate until the electrical cable 220 is in abutment with the second rest portion 184. Therefore, the masking and guide body 180 for the electrical cable 220 rotates with a first angular delay with respect to the support body 130. During a terminal phase of the rotation of the support body 130 the masking and guide body 180 for the electrical cable 220 does not rotate because the at least one bridge element 185 is in abutment on the second side wall 129 but the support body 130 keeps rotating determining a second angular delay of the masking and guide body 180 for the electrical cable 220 with respect to the support body 130.

Preferably, the first angular delay is comprised between 1° and 45°.

Preferably, the second angular delay is comprised between 1° and 45°.

Preferably, the first angular delay is substantially equal to the second angular delay.

When the hinge assembly for smart glasses 100 passes from the second stable closing position to the first stable opening position, the electrical cable 220 is drawn in rotation by the covering element 230 that leads it to detach from the second rest portion 184 until contacting the first rest portion 183. At this point, the electrical cable 220 draws in rotation the masking and guide body 180 for the electrical cable 220, the at least one bridge element 185 is detached from the second side wall 129 and rotates together with the masking and guide body 180 for the electrical cable 220 towards the first side wall 128 of the support plate 110.

Therefore, during an initial phase of the rotation of the support body 130 the masking and guide body 180 for the electrical cable 220 rotates with the second angular delay with respect to the support body 130. During a terminal phase of the rotation of the support body 130 the masking and guide body 180 for the electrical cable 220 does not rotate because the bridge element 185 is in abutment on the first side wall 128 but the support body 130 keeps rotating determining the first angular delay of the masking and guide body 180 for the electrical cable 220 with respect to the support body 130.

Therefore, the distance between said side walls 128, 129 is such as to determine the first angular delay between the rotation of the support body 130 and the rotation of the masking and guide body 180 for the electrical cable 220 and the second angular delay between the rotation of the support body 130 and the rotation of the masking and guide body 180 for the electrical cable 220.

In a particular embodiment of the present invention, as for example those illustrated in the attached figures, the cantilevered portions 113, 114 have a first through hole 115 and a second through hole 116 opposite and aligned with each other along a direction substantially parallel to the vertical axis z.

In such case, the support body 130 and the support plate 110 comprise respective interaction elements 118, 119, 134, 135 adapted to guide the reciprocal rotation of the support body 130 and the support plate 110 between the first stable opening position of the hinge assembly for smart glasses 100 and the second stable closing position of the hinge assembly for smart glasses 100.

The support body 130 comprises a third through hole 132 and a slotted through hole 133. The third through hole 132 and the slotted through hole 133 have axes parallel to each other and substantially parallel to the vertical axis z.

The support body 130 further comprises at least one housing chamber 138 open towards the outside and in communication with the slotted through hole 133.

Preferably, the at least one housing chamber 138 can be more than one.

In the illustrated embodiment, the support body 130 comprises two of said housing chambers 138, parallel to each other and disposed successively along the vertical axis z.

The hinge assembly for smart glasses 100 also comprises a first arm element 140 and a second arm element 150. The first arm element 140 and the second arm element 150 have respectively first perforated end portions 141, 151 and second perforated end portions 142, 152. The first perforated end portion 141 of the first arm element 140 is disposed at the first through hole 115 of the first cantilevered portion 113. The first perforated end portion 151 of the second arm element 150 is disposed at the second through hole 116 of the second cantilevered portion 114.

The hinge assembly for smart glasses 100 also comprises a first coupling element 122 and a second coupling element 123 crossing at least partially respectively the first through hole 115 and the second through hole 116 of the cantilevered portions 113, 114 of the support plate 110 and being coupled with the first perforated end portions 141, 151 of the first arm element 140 and the second arm element 150. The second perforated end portions 142, 152 of the first arm element 140 and the second arm element 150 are housed in the support body 130 so as to be coaxial with respect to the third through hole 132.

The hinge assembly for smart glasses 100 further comprises a first coupling pin 136 crossing the third through hole 132 of the support body 130 and the second perforated end portions 142, 152 of the first arm element 140 and the second arm element 150.

The second perforated end portions 142, 152 are free to rotate with respect to the first coupling pin 136. The first coupling pin 136 allows the rotation of the support body 130.

The hinge assembly for smart glasses 100 also comprises a third arm element 160 and a fourth arm element 170. The third arm element 160 and the fourth arm element 170 have respectively third perforated end portions 161, 171 and fourth perforated end portions 162, 172.

The third perforated end portions 161, 171 are rotatably coupled respectively to the first perforated end portions 141, 151 of the first arm element 140 and the second arm element 150. The fourth perforated end portions 162, 172 of the third arm element 160 and the fourth arm element 170 are housed in the support body 130 at the slotted through hole 133.

Furthermore, the hinge assembly for smart glasses 100 comprises a second coupling pin 137 crossing the slotted through hole 133 of the support body 130 and the fourth perforated end portions 162, 172 respectively of the third arm element 160 and the fourth arm element 170. The fourth perforated end portions 162, 172 are free to rotate with respect to the second coupling pin 137.

The hinge assembly for smart glasses 100 also comprises at least one elastic element 139 housed in the at least one housing chamber 138. In more detail, the at least one elastic element 139 is in contact with a bottom wall of the at least one housing chamber 138 on one side and in contact with the second coupling pin 137 on the other side.

Preferably, the at least one elastic element 139 can be more than one and in particular can be in number equal to the number of the housing chambers 138. In a particular embodiment, for example that illustrated in the attached figures, the at least one elastic element 139 are two springs, each housed in the respective housing chamber 138.

When the hinge assembly for smart glasses 100 is in the first stable opening position, it is possible to pass to a third unstable extra-opening position wherein the temples 312 are open beyond the first stable opening position, pushing in rotation the support body 130 in opposite direction to what would be made to reach the second stable closing position. Thereby, indeed, the support body 130 abuts on the second face 112 of the support plate 110. Forcing the rotation of the support body 130, the support body 130 is forced to rotate around an axis passing through the third through hole 132 and no longer for the axis passing through the first through hole 115 and the second through hole 116.

In the transition from the first stable opening position to the third unstable extra-opening position, the second coupling pin 137 slides in the slotted through hole 133 to a first endstroke end 133′ defining the third unstable extra-opening position. Thereby, the second coupling pin 137 compresses the at least one elastic element 139 housed in the at least one housing chamber 138; thereby, once released the support body 130, the hinge assembly for smart glasses 100 returns from the third unstable extra-opening position to the first stable opening position because of the return elastic force of the at least one elastic element 139 that, elongating, pushes the second coupling pin 137 sliding the latter in the slotted through hole 133 towards a second endstroke end 133″ opposite to the first 133′.

Thus, the second coupling pin 137 controls the translation and thus the opening of the temple 312 in the third unstable extra-opening position.

Preferably, the interaction elements 118, 119, 134, 135 comprise a first guide groove 118 made on the first cantilevered portion 113 and a second guide groove 119 made on the second cantilevered portion 114 describing an arc of circumference.

Each of such guide grooves 118, 119 comprises respectively a first endstroke abutment 120, 120′ and a second endstroke abutment 121, 121′.

Preferably, the guide grooves 118, 119 are comparable to cams and are arranged at perimeter ends of the cantilevered portions 113, 114 respectively around the first through hole 115 and the second through hole 116.

The interaction elements 118, 119, 134, 135 also comprise a first protrusion 134 and a second protrusion 135, comparable to stop: rolls, made on said support body 130 resting respectively in the first guide groove 118 and in the second guide groove 119 and are adapted to slide in them between the first endstroke abutment 120, 120′ and the second endstroke abutment 121, 121′ when the support body 130 rotates with respect to the support plate 110 around an axis passing through the first through hole 115 and the second through hole 116 of the cantilevered portions 113, 114.

In more detail, when the hinge assembly for smart glasses 100 is in the first stable opening position, the first protrusion 134 and the second protrusion 135 are both in contact and in abutment with the first endstroke abutments 120, 120′ of the first guide groove 118 and the second guide groove 119 respectively; when the hinge assembly for smart glasses 100 is in the second stable closing position, the first protrusion 134 and the second protrusion 135 are both in contact and in abutment with the second endstroke abutments 121, 121′ of the first guide groove 118 and the second guide groove 119 respectively.

When the hinge assembly for smart glasses 100 passes from the first stable opening position to the second stable closing position, the first protrusion 134 and the second protrusion 135 slide respectively along the first guide groove 118 and the second guide groove 119 from the first endstroke abutments 120, 120′ to the second endstroke abutments 121, 121′; during such step, the support body 130 makes a first rotary movement around the axis passing through the first through hole 115 and the second through hole 116 of the cantilevered portions 113, 114 of the support plate 110 quantifiable with a determined first angular excursion.

Vice versa, when the hinge assembly for smart glasses 100 passes from the second stable closing position to the first stable opening position, the first protrusion 134 and the second protrusion 135 slide respectively along the first guide groove 118 and the second guide groove 119 from the second endstroke abutments 121, 121′ to the first endstroke abutments 120, 120′; during such step, the support body 130 makes a second rotary movement around the axis passing through the first through hole 115 and the second through hole 116 of the cantilevered portions 113, 114 of the support plate 110 in opposite direction with respect to that previously described and quantifiable with a determined second angular excursion equal and opposite to the first angular excursion of the first rotary movement.

Passing from the first stable opening position to the second stable closing position the electrical cable 220 is not subjected to the first angular excursion, but to a third angular excursion obtained by subtracting the first angular delay and the second angular delay from the first angular excursion. Preferably, as observable in figure, the third angular excursion is 45 degrees.

When the hinge assembly for smart glasses 100 passes from the first stable opening position to the third unstable extra-opening position, the first protrusion 134 and the second protrusion 135 pass from a condition corresponding to the first stable opening position in which they are in contact with the first endstroke abutments 120, 120′, to a condition corresponding to the third unstable extra-opening position in which they are not in contact and are respectively outside the first guide groove 118 and the second guide groove 119.

Preferably, the first perforated end portions 141, 151 have around their hole cylindrical delimitation walls 143, 153 that protrude for a section of length beyond the surface of such portions respectively towards the first cantilevered portion 113 and the second cantilevered portion 114; in such case, the third perforated end portions 161, 171 are placed on the first perforated end portions 141, 151 such that the respective holes are coaxial and the cylindrical delimitation walls 143, 153 penetrate the respective holes of the third perforated end portions 161, 171. Thereby, the third arm element 160 is free to rotate with respect to the first arm element 140 around the axis of the holes of the first perforated end portion 141 of the first arm element 140 and the third perforated end portion 161 of the third arm element 160; similarly, the fourth arm element 170 is free to rotate with respect to the second arm element 150 around the axis of the holes of the first perforated end portion 151 of the second arm element 150 and the third perforated end portion 171 of the fourth arm element 170.

Preferably, the first perforated end portions 141, 151 have threaded holes.

In such case the first coupling element 122 and the second coupling element 123 have corresponding threaded ends 124, 125 adapted to couple with the threaded holes of the first perforated end portions 141, 151.

The first coupling element 122 and the second coupling element 123 further have respective cylindrical portions 126, 127 adapted to allow the rotation of the coupling elements 122, 123 within the first through hole 115 and the second through hole 116.

The first coupling element 122 and the second coupling element 123 are for example made in a screw shape having the threaded terminal portion of the stem and an intermediate non-threaded cylindrical portion.

Preferably, the first perforated end portion 141 of the first arm element 140 is interposed between the first end 181 of the masking and guide body 180 for the electrical cable 220 and the first cantilevered portion 113. The first perforated end portion 151 of the second arm element 150 is interposed between the second end 182 of the masking and guide body 180 for the electrical cable 220 and the second cantilevered portion 114.

Preferably, the rest portions 183, 184 have two perimeter stop walls 186, 187 that protrude along a direction substantially parallel to the vertical axis z beyond the first end 181 and the second end 182 making two housing seats for the first perforated end portions 141, 151.

The masking and guide body 180 for the electrical cable 220 cannot escape from the receiving seat 117 as its movement in a vertical direction z is limited by the presence of the first perforated end portions 141, 151 and the third perforated end portions 161, 171, in the transverse plane xy its movement is limited by the interference between the perimeter stop walls 186, 187 and the respective first perforated end portions 141, 151 and third perforated end portions 161, 171.

Instead, the masking and guide body 180 for the electrical cable 220 is free to rotate around the axis passing through the first through hole 115 and the second through hole 116.

The features of the hinge assembly for smart glasses being object of the present invention are apparent from the provided description, as well as the related advantages are apparent.

Indeed, the hinge assembly for smart glasses according to the present invention allows to house a flexible cable therein, preventing the excessive stress exerted by the hinge on the cable itself from damaging or breaking it.

Furthermore, the angular delays provided between the rotations of the masking and guide body for an electrical cable and the support body allow to prevent the electrical cable from being subjected to critical bending which could damage the electrical cable itself.

Furthermore, the hinge assembly for smart glasses according to the present invention is bistable and is simultaneously able to reach an extra-opening position.

Finally, it is apparent that the hinge assembly for smart glasses thus conceived are susceptible to a number of modifications and variations, all falling within the invention; furthermore, all the details are replaceable by technically equivalent elements. In practice, the used materials, as well as the sizes, can be any, depending on the technical requirements.

1. Hinge assembly for smart glasses (100) comprising:
a support plate (110) having a first face (111) substantially flat intended to be applied to a front (311) of a frame (310) for glasses (300), and a second face (112) substantially flat opposite and parallel to said first face (111), said support plate (110) comprising a first cantilevered portion (113) and a second cantilevered portion (114) parallel and opposite to each other extending from said second face (112) in a direction substantially perpendicular to it, said support plate (110) comprising an opening (190) positioned along the vertical direction z between said first cantilevered portion (113) and said second cantilevered portion (114), said support plate (110) comprising a first side wall (128) and a second side wall (129) connecting said first cantilevered portion (113) to said second cantilevered portion (114);
a support body (130) intended to be applied to a temple (312) for glasses (300), said support body (130) being rotatably coupled to said support plate (110) so as to be able to rotate between a first stable opening position of said hinge assembly for smart glasses (100) and/or a second stable closing position of said hinge assembly for smart glasses (100);
a masking and guide body (180) for an electrical cable (220) extending along the axis z between a first end (181) and a second end (182) and is interposed between said cantilevered portions (113, 114) such that said first end (181) faces said first cantilevered portion (113) and said second end (182) faces said second cantilevered portion (114), said masking and guide body (180) for the electrical cable (220) comprising a first rest portion (183) and a second rest portion (184) spaced from each other extending in length between the first end (181) and the second end (182) and at least one bridge element (185) connecting said rest portions (183, 184) to each other, said rest portions (183, 184) facing each other and defining a free gap between them, said at least one bridge element (185) is in contact and in abutment with said first side wall (128) of said support plate (110) when said hinge assembly for smart glasses (100) is in the first stable opening position, said at least one bridge element (185) is in contact and in abutment with said second side wall (129) of said support plate (110) when said hinge assembly for smart glasses (100) is in the second stable closing position, the distance between said side walls (128, 129) is such as to determine a first angular delay between the rotation of said support body (130) and the rotation of said masking and guide body (180) for the electrical cable (220) and a second angular delay between the rotation of said support body (130) and the rotation of said masking and guide body (180) for the electrical cable (220).

2. Hinge assembly for smart glasses (100) according to claim 1 wherein said first angular delay is substantially equal to said second angular delay.

3. Hinge assembly for smart glasses (100) according to claim 1 wherein said first angular delay is comprised between 1° and 45° and said second angular delay is comprised between 1° and 45°.

4. Hinge assembly for smart glasses (100) according to claim 1 wherein:
said cantilevered portions (113, 114) have respectively a first through hole (115) and a second through hole (116) opposite and aligned with each other along a vertical direction z,
said support body (130) and said support plate (110) comprising respective interaction elements (118, 119, 134, 135) adapted to guide the reciprocal rotation of said support body (130) and said support plate (110) between the first stable opening position of said hinge assembly for smart glasses (100) and the second stable closing position of said hinge assembly for smart glasses (100), said support body (130) comprising a third through hole (132) and a slotted through hole (133) having axes parallel to each other and substantially parallel to said vertical direction z, said support body (130) comprising at least one housing chamber (138) open towards the outside and in communication with said slotted through hole (133),
said hinge assembly for smart glasses (100) comprises:
a first arm element (140) and a second arm element (150) having respective first perforated end portions (141, 151) arranged respectively at said first through hole (115) and said second through hole (116) of said cantilevered portions (113, 114), and respective second perforated end portions (142, 152) housed in said support body (130) at said third through hole (132), a first coupling pin (136) crossing said third through hole (132) and said second perforated end portions (142, 152), a first coupling element (122) and a second coupling element (123) crossing at least partially respectively said first through hole (115) and said second through hole (116) and coupling respectively with said first perforated end portions (141, 151);
a third arm element (160) and a fourth arm element (170) having respective third perforated end portions (161, 171) rotatably coupled respectively to said first perforated end portions (141, 151) and respective fourth perforated end portions (162, 172) housed in said support body (130) at said slotted through hole (133), a second coupling pin (137) crossing said slotted through hole (133) and said fourth perforated end portions (162, 172);
at least one elastic element (139) housed in said at least one housing chamber (138) on one side, in contact with a bottom wall of said at least one housing chamber (138) on the other side, in contact with said second coupling pin (137), said at least one elastic element (139) being compressed by said second coupling pin (137) when the hinge assembly for smart glasses (100) passes from said first stable opening position to a third unstable extra-opening position, said at least one elastic element (139) pushing said second coupling pin (137) to return from the third unstable extra-opening position to the first stable opening position.

5. Hinge assembly for smart glasses (100) according to claim 4, wherein said interaction elements (118, 119, 134, 135) comprise:
a first guide groove (118) made on said first cantilevered portion (113),
a second guide groove (119) made on said second cantilevered portion (114),
a first protrusion (134) and a second protrusion (135) made on said support body (130), said guide grooves (118, 119) describing an arc of circumference and comprising respectively a first endstroke abutment (120, 120′) and a second endstroke abutment (121, 121′), said first protrusion (134) and said second protrusion (135) resting respectively in said first guide groove (118) and in said second guide groove (119) and being adapted to slide in them between the first endstroke abutment (120, 120′) and the second endstroke abutment (121, 121′), said first protrusion (134) and said second protrusion (135) both being in contact and in abutment with said first endstroke abutments (120, 120′) when said glasses hinge assembly for smart glasses (100) is in the first stable opening position, said first protrusion (134) and said second protrusion (135) both being in contact and in abutment with said second endstroke abutments (121, 121′) when said hinge assembly for smart glasses (100) is in the second stable closing position.

6. Hinge assembly for smart glasses (100), according to claim 4, wherein said first perforated end portions (141, 151) have around their hole cylindrical delimitation walls (143, 153) that protrude for a section of length beyond the surface of said portions respectively towards said first cantilevered portion (113) and said second cantilevered portion (114), said first coupling element (122) and said second coupling element (123) having corresponding threaded ends (124, 125) adapted to couple with the threaded holes of said first perforated end portions (141, 151), said first coupling element (122) and said second coupling element (123) having respective cylindrical portions (126, 127) adapted to allow the rotation of said coupling elements (122, 123) within said first through hole (115) and said second through hole (116).

7. Hinge assembly for smart glasses (100), according to claim 4, wherein said at least one elastic element (139) are two and in number equal to the number of said at least one housing chamber (138).

8. Hinge assembly for smart glasses (100), according to claim 4, wherein said first perforated end portion (141) of said first arm element (140) is interposed between said first end (181) of the masking and guide body (180) for the electrical cable (220) and said first cantilevered portion (113), said first perforated end portion (151) of said second arm element (150) is interposed between said second end (182) of the masking and guide body (180) for the electrical cable (220) and said second cantilevered portion (114).

9. Hinge assembly for smart glasses (100), according to claim 4, wherein said first rest portion (183) and said second rest portion (184) have two perimeter stop walls (186, 187) that protrude along a direction substantially parallel to the vertical axis z beyond said first end (181) and said second end (182) making two housing seats for said first perforated end portions (141, 151).

10. Smart glasses (300) comprising:
a front (311) adapted to carry two lenses and two temples (312), said temples (312) adapted to allow a user to wear glasses (300);
two hinge assemblies for smart glasses (100) according to claim 1, each of which couples a respective temple (312) to said front (311).
an electrical cable (220) adapted to electrically connect electrical and/or electronic devices to each other that are installed in said front (311) and in said temples (312), said electrical cable (220) coming from said front (311) of said glasses (300) crossing said opening (190) of said support plate (110) and the gap between said rest portions (183, 184) reaching the respective temple (312).
